(19) United States
(12) Patent Application Publication
(10) Pub. No.: US 2024/0295283 A1
(43) Pub. Date: Sep. 5, 2024

(54) NON-PERMANENT INLET FLANGE AND METHOD FOR CUSTOM INSERT

(71) Applicant: MasterTek Flow Technologies, LLC, Chattanooga, TN (US)

(72) Inventors: Stephen W. BRANDON, Chattanooga, TN (US); Joseph K. EDWARDS, Chattanooga, TN (US)

(73) Assignee: MasterTek Flow Technologies, LLC, Chattanooga, TN (US)

(21) Appl. No.: 18/117,291

(22) Filed: Mar. 3, 2023

(51) Int. Cl. F16L 55/04; F28F 19/00

(52) U.S. Cl. CPC F16L 55/04; F28F 19/002

(57) ABSTRACT

A non-permanent protective insert which acts as a barrier to protect against flow induced erosion and contains an inlet flange which aids in extraction is disclosed. The non-permanent insert is able to customize its features and specifications to allow for infinite configurations. The non-permanent protective insert is able to withstand high-turbulence flow transition zones, varying temperature ranges, and various corrosive and erosive media and is used in simple to complex infrastructures.

### FIELD

The present invention is directed to a non-permanent, flanged insert which is placed into a pipe, tube, or other conduit infrastructure and which becomes a barrier to protect against flow induced tube damage and which incorporates features into the flange to aid in its extraction. In addition, it discloses a method for custom inserts depending on the system need. The disclosed invention includes the method of installing the non-permanent insert which will provide numerous benefits such as improved longevity and better maintenance of established systems.

### BACKGROUND OF THE INVENTION

The need for liners or devices which reduce the rate of erosion within tube walls has long been present in the prior art. When a liquid flows from a reservoir into a tube, it undergoes an abrupt change in velocity and consequently, an abrupt change in pressure, so that just within the orifice of the tube, the stream may contract away from the wall of the tube and then expand against to fill the tube. The pressure drop at the contracted point in the stream may cause dissolved gases to separate from the stream and to collect in the space between the stream and the tube wall. The presence of such gases promotes corrosion of the tube wall adjacent, and along the interior of, the tube. To combat this corrosion or erosion, insert liners are used in the inlet ends of the tubes to prolong the life of the tube. See U.S. Pat. No. 2,143,477.

Prior inventions were constructed of relatively heavy metal to increase the life span of the leak stopper, while attempting to prolong the life of the tube and prevent deterioration of the tube. See U.S. Pat. No. 2,716,428. Other prior disclosures provided for insulating tube inserts, which reduced thermal stresses and the overall temperatures in high temperature operations. See U.S. Pat. No. 3,592,261. Other prior art disclosed inserts designed with flared ends to reduce turbulence, but which were made of expensive alloys and required a high degree of maintenance. U.S. Pat. No. 3,707,186. These “ferrules” (the entry portion featuring a tubular member), are often a key component of heat exchangers and are concerned with protecting the entry portion of tubes of a heat exchanger from over-heating while still cooling the flowing stream about half as much as without such protection. Some of these protective inserts however, such as U.S. Pat. No. 4,396,059, were not intended to be non-permanent, but rather were intended to reduce the erosion at the inlet end of the condenser tube. Therefore, they did not need to contain features which would enable casy removal.

The present invention deviates from this use in the prior art as it can be used in any tube configuration where inlet damage from erosion is of concern and may be produced in suitable material and geometry to address specific design features of the system, some of which include fluid media, temperatures, pressures, tube configuration, fluid volume and velocities, corrosives, and erosion producing products. Further, the design integrates specific features into the flange to allow the insert to be more easily removed for inspection or other maintenance activities at user prescribed intervals. This necessitates the insert being made of a material which can survive the flow of the media for the prescribed period of time between maintenance cycles. Another embodiment of this invention is to provide the insert as a non-permanent liner which is able to extend the life of the system in which it is installed. None of the prior art disclosures contain all of these elements in combination as needed in the disclosed invention.

Each insert needs to be custom sized to suit the tube in which it will be utilized, as it needs to allow for adequate flow of process fluids, minimize deleterious pressure drops which may cause additional erosion risks, and allow insertion and removal in an economic time period during maintenance, all while providing sufficient protection to the tube. These liners need to be non-permanent and benefit through features which aid in extraction. While the prior art has disclosed a variety of non-permanent liners, this disclosure contains a flange that is attached to the insert which aids in the extraction of the non-permanent insert. While the prior art has disclosed the advantageousness of such an element, it is only disclosed as a contour for flow diversion. See U.S. Pat. No. 9,279,605. While this liner was directed at condensers for refrigerant circuits, and thus had a different need, the present invention solves the existing problem in the prior art which relates to extraction.

There is substantial economic benefit for a system that protects tubes and pipes from erosion during use. As erosion creates wall perforations in tubes, owners are forced to plug the flow of media through the compromised tubes, typically through insertion of permanent metallic plugs. As the efficiency of the system is related to the aggregate surface area of the tubes through which the media flows, this results in a loss of heat transfer efficiency in the system, eventually resulting in the need to perform expensive replacement of the tubes. This insert creates a protective barrier resulting in longer expected life of heat exchanger tubes before replacement is required.

The problem addressed by this disclosure is that of a specifically featured flange attached to a non-permanent insert which aids in extraction of the insert. In the preferred embodiment, this disclosure addresses the need for a customized approach to each barrier, as necessary, to produce the required interface for the extraction while not deleteriously impacting fluid flow into the tube.

All of the prior art tubular inserts, even those with concave features therein, fail to address the need for a design which enables extraction. The present disclosure meets this need, and in a cost-effective manner while still providing the necessary structure and materials needed to assure the primary purpose of protection, all in a non-permanent insert.

REFERENCES

| | | |
|---|---|---|
| U.S. Pat. No. 2,143,477 | DILLON | 1939 |
| U.S. Pat. No. 2,716,428 | PENNELLA | 1955 |
| U.S. Pat. No. 3,592,261 | BLACK | 1971 |
| U.S. Pat. No. 3,707,186 | ZORRILLA | 1971 |
| U.S. Pat. No. 4,019,871 | ANDERSON | 1977 |
| U.S. Pat. No. 4,254,819 | WORRELL | 1981 |
| U.S. Pat. No. 4,396,049 | BANNER | 1981 |
| U.S. Pat. No. 9,279,605 | FORSTER | 2016 |
| U.S. Pat. No. 10,260,517 | ORTEGA | 2019 |
| U.S. Pat. No. 11,285,405 | JOHNSON | 2022 |

### BRIEF SUMMARY OF INVENTION

The primary objective of the invention is to provide a customizable, cost-effective product, in a material which can withstand a variety of temperatures, material, and which is non-conductive, non-flexible, non-permeable, and non-permanent. In certain embodiments, this invention is reusable for insertion into tubes, pipes, or conduits after maintenance activities.

The presently disclosed invention relates to a custom molded, printed or otherwise manufactured insert barrier, comprised of plastic, metal, ceramic or other suitable material depending on system parameters, which protects against flow induced erosion and prevents future failures by protecting the transition zone of the structure both as a barrier and flow modifier. It contains a unique feature to assist in the removal of the insert after use without the need to insert tooling into the structure, thereby preventing potential damage to the structure. This inlet flange is an integral component of the insert design including the features allowing for easy removal 110. In certain embodiments, this disclosure is made up of polymer, plastic, or suitable metal depending on the conditions into which it will be inserted.

The present invention discloses a feature that aids in extraction. It is recessed 120 in this embodiment, but may also be raised to provide similar interface, to help in this extraction feature.

The present invention extends the life of a heat exchanger in operation in certain embodiments.

The present invention operates as a sleeve, inserted into the transition zone of a tube, and enables the efficient movement of process media into the tube, while providing protection.

### BRIEF DESCRIPTION OF THE DRAWINGS

The invention will be explained in more detail below on the basis of at least one exemplary embodiment and with reference to the drawings, in which:

FIG. 1 shows a schematic illustration of the insert according to an embodiment of the invention.

FIG. 2 shows a linear cross-cut of the insert according to an embodiment of the invention.

FIG. 3 shows the outer view of the inlet flange along the length of the insert.

FIG. 4 shows a close-up of the inlet flange as seen in FIG. 3.

FIG. 5 shows a diameter cross-section of the insert from the flared lip circumference of the insert.

FIG. 6 shows a linear view of the tube insert with a horizontal line to demonstrate the cross-section angel in FIG. 5 and FIG. 7.

FIG. 7 shows a diameter cross-section of the insert along the mid-range.

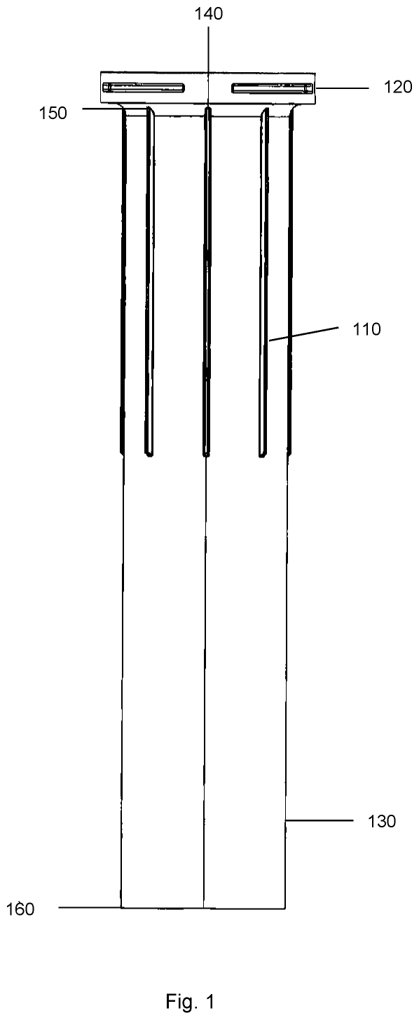

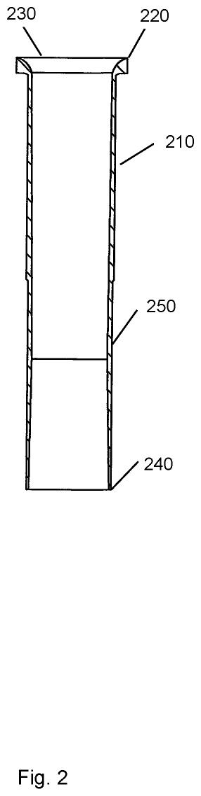

### DETAILED DESCRIPTION AND BEST MODE OF IMPLEMENTATION

The best mode of implementation is a custom manufactured non-permanent flanged insert which becomes a barrier to protect against flow induced erosion in high-turbulence flow zones and discloses a feature that aids in extraction. This feature utilizes recesses and ridges integrated into the inlet flange described herein to aid in extraction. The non-permanent flange insert is non-permeable, and is manufactured in a material suited to the environment, as well as being able to handle a wide disparity in temperatures.

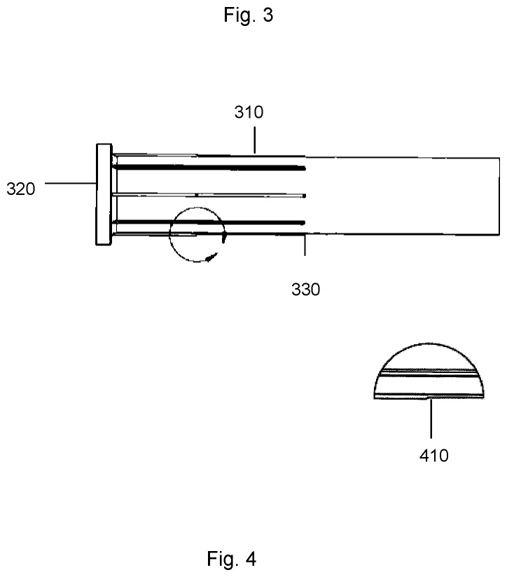

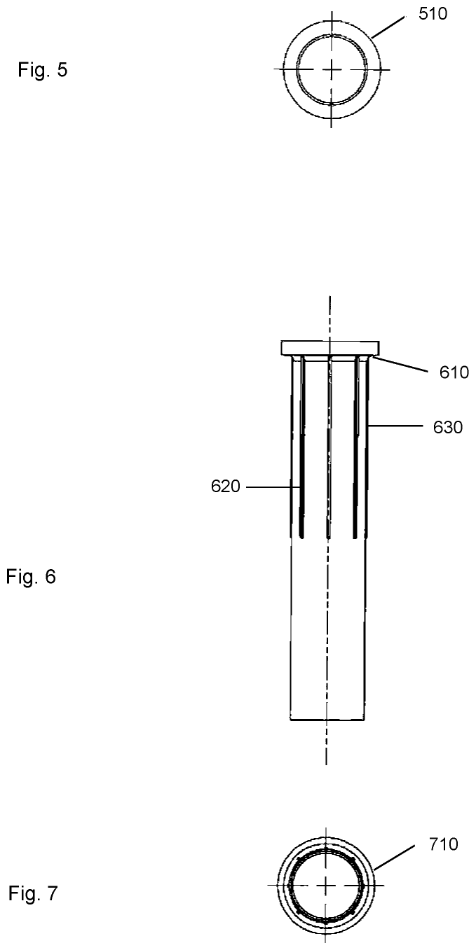

The insert is a smooth cylinder 130 with protruding splines equally spaced 110 that start from the flared circumference flange of the insert 140 and continue down a portion of the length of the insert. Recesses 120 perpendicular to the splines along the rim of the flared flange circumference enhance the removal feature. In certain embodiments, these recesses may be ridges that provide attachment points for a removal tool. The flared flange lip descends 150 steeply where it meets with the body of the tube insert and continues to the opposing end circumference 160. Wall strengthening supports 210 the length of the insert while curved wall supports 220 strengthen the flared circumference lip 230 of the insert. The cavity between the wall supports gradually decrease from the flared flange circumference lip down the length of the insert to the opposing end circumference 240. An internal spline perpendicular to the external splines encircles the inside of the insert 250. FIG. 3 shows a linear view of the splines 310 and the flared flange lip circumference 320. FIG. 4, shows a close up of the splines, with a focus on the inlet flange 410. In this figure, the splines extend approximately hallway down the length of the insert prior to tapering into the insert 330, although the geometry may be varied based on specific forces in the system being protected. FIG. 5 shows a cross-section of the flared flange lip circumference of the insert 510. FIG. 6 demonstrates a view of the flared flange lip circumference 610 as it descends into the linear tube and spline portion of the insert 620. At 630 the taper from the inlet flange into the spline is visible. FIG. 7 illustrates a cross section of the insert to demonstrate the splines proportionality and internal structure 710.

The present invention is reusable in the structure in which it is customized to fit, allowing for repairs as necessary in the future, although it is expected most users will elect to replace the invention after initial removal.

In another preferred embodiment, this disclosure reduces the rate of local erosion corrosion of the infrastructure or tube in which it is placed.

In another preferred embodiment, this disclosure is designed to modify the fluid flow and reduce the overall effect of turbulence in the transition zone.

In another preferred embodiment, this disclosure varies depending on the infrastructure and dimensions of the heat exchanger. The inputs include tube size, heat exchanger capacity, flow rates, temperature ranges, fluid composition, and entrained solids. This input effects the physical configuration of the embodiment of the disclosure and the material selection for the environment.

What is claimed is:

1. A non-permanent protective insert for use with a tube, a conduit, or a pipe, comprising:
a main body, made up of a front end and a back end;
a fluid diverting element located on the front end with a flared flange lip;
the flared flange lip containing a multitude of recesses and ridges;
a multitude of splines, encircling the flared flange lip, tapering from the flared flange lip into the main body;
the multitude of splines attaching to an inlet flange extending beyond an individual spline which then tapers into the individual spline at a mid-point along the splines to aid in extraction; and
an amount of internal hydraulic forms or tapers critical to flow performance.

2. The non-permanent protective insert as identified in claim 1 wherein the protective insert is made up of a polymer, specifically formulated to withstand a range of system temperatures, a plastic, a metal, a ceramic, or a material specifically formulated to protect against fluid media, temperature, and contaminants of the system being protected.

3. The non-permanent protective insert as identified in claim 1 wherein the flared flange lip contains a multitude of recesses or ridges.

4. The non-permanent protective insert as identified in claim 1 in which the inlet flange has recessed features designed to provide interface with a tool or operator to aid in extraction of the protective insert.

5. The non-permanent protective insert as identified in claim 1 in which the inlet flange has raised features designed to provide interface with a tool or operator to aid in extraction of the protective insert.

6. The non-permanent protective insert as identified in claim 1 in which the inlet flange transitions into a spline or series of splines around the circumference of the inserts which then taper into the main body thereof.

7. A method of customization for a protective non-permanent insert in which the design is modified to produce the specific geometry for the optimum protective insert, said method comprising the steps of:
A. An amount of measurements of the existing infrastructure to determine features of a protective non-permanent insert including:
1. a tube size, a heat exchanger capacity, a flow rate, a temperature range, a fluid composition, and an amount and composition of entrained solids to produce a physical configuration of the invention; and
2. a material selection for best performance of the protective non-permanent insert.
B. The protective non-permanent insert containing inlet flange designed to withstand varying temperatures and high-turbulence flow transition zones is produced;
C. A site-specific installation occurs enabling protection of the heat exchanger tubes; and
D. The protective non-permanent insert is removed utilizing the inlet flange and recesses.

8. The method according to claim 7 in which the protective non-permanent insert utilizes installation-specific computational fluid dynamics analysis to create the optimal insert.

9. The method according to claim 7 in which the protective non-permanent insert is made of materials enabling multiple use insertions.
